(19) United States
(12) Patent Application Publication
(10) Pub. No.: US 2006/0235340 A1
(43) Pub. Date: Oct. 19, 2006

(54) Therapeutic recliner

(76) Inventor: Sharon Rose Gibson, Shreveport, LA (US)

Correspondence Address: Sharon Rose Gibson, 4218 Chamberlain Drive, Shreveport, LA, 71109, US

(21) Appl. No.: 11/105,710

(22) Filed: Apr. 15, 2005

(51) Int. Cl. A61H 1/00

(52) U.S. Cl. 601/15; 601/49; 601/90; 601/98

(57) ABSTRACT

An upholstered home reclining chair of fabric, vinyl or leather designed with motors and gears in the chair base that will provide low-resistance movement of all extremities either individually or in concert and optionally a reclining position(s). The chair will have pivot points so the joints of the shoulders, elbows, hips, knees and ankles will be in a resting state while mild straps, restraints or pockets secure the limbs for movement of the upper arms, forearms, thighs, calves, and ankles. The limb movements will be in every natural direction of that particular limb. A programmable computer chip can dictate the degree of movement of each extremity and a remote control will activate the movements, heat and massage features.

### BACKGROUND OF THE INVENTION

Accordingly, the invention is a recliner that will move every limb or only one limb and optionally provide massage and/or heat therapy. The chair will have a programmable chip inside to allow selected degrees of movement needed and tailored to the individual as well as each limb. A remote control device will activate the motors and gears inside the chair. Each shoulder, elbow, upper thigh, calf and foot will be able to move to the prescribed degree programmed in the chip. The chair will have hook and loop restraints to assist the resting state of the body while limbs are in a moving state to keep the body in the proper position for the movements. The chair can recline in any position of comfort up to an almost supine position with or with out the movement and still activate the heat and massage features.

### SUMMARY OF THE INVENTION

This invention relates generally to a relaxation chair that reclines and supports the individual while multiple pivot points correlating to each major joint in the body provides low-resistance movement, heat and massage which is programmed and tailored to individual needs.

The invention provides minimum to maximum range of motion for each joint while the body is in a resting state, while one or more body parts are secured and protected by straps to ensure the relaxation state. Also, it is an aid to those who have little to no muscle control such as individuals with semi or complete paralysis, muscular distrophy, etc. In order to achieve the maximum leg exercise benefit, the back lowers to an almost supine position.

The chair will also allow for small minute movements to keep the joints warmed up for those patients who have illnesses such as arthritic conditions, fibromyalgia and chronic myofascial pain syndromes. These conditions cause pain when in a resting state especially a prolonged resting state when they attempt to move or adjust their position. By using the small minute movements, the joints will be “warmed up” for the person to adjust their position or get out of the chair

The programming mechanism allows for multiple programs for one or multiple people which are activated by the remote control. Ideally, a data outlet could be part of the programming device to access the chip.

This device would be desirable for all individuals needing a low resistance type of movement as a form of mild exercise as a prelude to more vigorous exercise or just to prevent stiffening of joints and muscles with inactivity.

Other objectives, advantages and novel features of the invention will become more apparent from the following description when taken in conjunction with the accompanying drawings.

Even though numerous characteristics and advantages of the present invention have been set forth in the description, together with details of the structure and function of the invention, the disclosure is illustrative only, and changes may be mad in detail, especially in matters of shape, sizes to be offered, and arrangement of parts within the principles of the invention to the full extent indicated by the broad general meaning of the terms in which the attached claims are expressed.

### BRIEF DESCRIPTION OF THE DRAWINGS

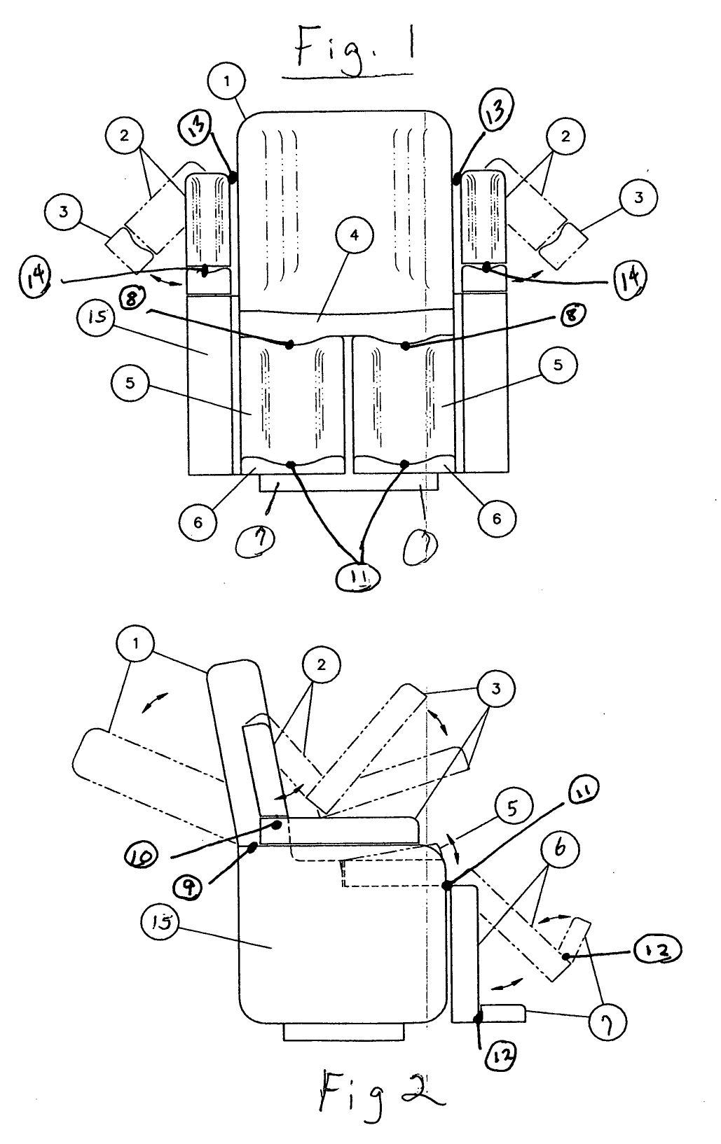

All descriptions apply to both FIGS. 1 and 2

1 Chair back—Motion involves upright to any position to an almost supine position to enable maximum leg movement. A trunk strap will enable the body to be supported if body is unable to support itself in an upright position.

2 Upper arm supports—With aid of hook and loop straps, allows minimum to maximum flexion and extension t of upper arms as well as minimum to maximum median and lateral movement.

3 Forearm supports—With aid of hook and loop straps, or a pocket for the forearms allows minimum to maximum flexion and extension of forearms.

4 Seat support—Is basically a stationary seat that will have a slight glide to allow for the reclining position as well as proper leg movement.

5 Thigh supports—With aid of hook and loop straps, allows minimum to maximum flexion and extension t of thighs as well as minimum to maximum median and lateral movement.

6 . Calf supports—With aid of hook and loop straps, allows minimum to maximum flexion and extension of lower leg.

7 Foot supports—With aid of toe stirrups and hook and loop straps, allows minimum to maximum flexion and extension.

8 Pivot joints to allow for movement of thigh section from seat part 5 from 4

9 Pivot joints to allow for reclining back from seat parts 1 and 4

10 Pivot joints to allow forearm movement of parts 2 and 3

11 Pivot joints to allow for movement of parts 4 and 5

12 Pivot points to allow for movement of parts 5 and 6

13 Pivot joints to allow for movement of part 2 from 1

14 Pivot joints to allow for movement of part 3 from 2

15 Chair Base—A standard square recliner chair base and frame which will house motors and computer chip for programming application and also housing the box for wiring of the remote control. The chair base splits at the thigh juncture to allow for upper leg mobility both laterally and medially.

1. What is claimed is a recliner that will move every limb in concert or only one limb and optionally provide massage and/or heat therapy. The chair will have a programmable chip inside to allow selected degrees of movement needed and tailored to the individual as well as each limb. A remote control device will activate the motors and gears inside the chair. Each shoulder, elbow, upper thigh, calf and foot will be able to move according to the prescribed degree chip. The individual will have light hook and loop restraints to assist the resting state of the body while limbs are in a moving state. The chair can recline in any position of comfort up to an almost supine position with or with out the movement and still activate the heat and massage features.

2. The method as claimed in 1, further including the shoulder joint will aid the upper arm(s) to move out from the body and back in both medially and laterally, and up and down as the degrees are programmed.

3. The method as claimed in 1, further including the elbow join will aid the forearm(s) to move both up and down as well as laterally and medially as the degrees are programmed.

4. The method as claimed in 1, further including the back movement in a straight sitting position and reclining into an almost supine position as the degrees are programmed.

5. The method as claimed in 1, further including the seat remaining stationary as the upper leg is moved at the hip pivot point both up and down as well as medially and laterally as the degrees are programmed.

6. The method as claimed in 1, further including the lower leg movement at the knee pivot point both up and down as the degrees are programmed.

7. The method as claimed in 1, further including the foot movement at the ankle pivot point both up and down as well as medially and laterally as the degrees are programmed.

8. The method as claimed in 1, further a method of operating the chair is by a programmable computer chip according to individual needs and activated by remote control.

9. The method as claimed in 1, further including heat that can be applied according to the degree selected in conjunction or separate from the programmed movement.

10. The method as claimed in 1, further including massage that can be applied according to degree of strength while in a resting state.

11. The method as claimed in 1, further including a remote control to program and activate the programmed movements.

12. The method as claimed in 1, further including a programmable computer chip to accept commands for movement of limbs and the degrees of said movement allowing a number of programs that can be activated.

13. The method as claimed in 1, further including hook and loop strapping that will secure limbs to ensure a “resting state” while the chair is in motion as well as providing support for individuals who cannot support themselves in upright positions.
